(19) United States
(12) Patent Application Publication
(10) Pub. No.: US 2005/0174801 A1
(43) Pub. Date: Aug. 11, 2005

(54) Backlight

(76) Inventor: Densen Cao, Sandy, UT (US)

Correspondence Address: Parsons Behle & Latimer;Suite 1800, 201 South Main Street, P.O. Box 45898, Salt Lake City, UT, 84111, US

(21) Appl. No.: 10/773,090

(22) Filed: Feb. 5, 2004

(51) Int. Cl. F21V 5/00

(52) U.S. Cl. 362/575

(57) ABSTRACT

An backlight for illuminating a physical space for use by humans has been invented. In one example the backlight includes at least one semiconductor chip that can emit light mounted to a primary heat sink. The primary heat sink is mounted to a secondary heat sink and a heat sink grid is provided to dissipate heat to the atmosphere. Other examples are also disclosed.

### I. BACKGROUND

This disclosure relates to the field of backlights which may be used to illuminate a subject for microscopic observation. Traditionally when a material was placed on a microscope for magnification and viewing, a light was illuminated behind the material to be magnified. Those lights were often traditional light bulbs which may create excessive heat, produce light across a broad spectrum of wavelengths rather than only in a desired wavelength band, or could not be directed or focused in a desired direction.

### II. SUMMARY

Backlights are described that are capable of providing illumination for use with a microscope or other magnifying device. The backlights may utilize a semiconductor light source, provide a flexible arm for precise light positioning, provide for operation by a user's foot to leave the user's hands free, provide light of a specific wavelength desired, and focus or direct light for proper light beam profile. Heat management is provided by a heat sink arrangement that avoids creation of excessive heat.

### III. BRIEF DESCRIPTION OF THE DRAWINGS

FIG. 1 depicts a perspective view of an example backlight.

FIGS. 2a and 2b depict cross sectional views of example backlight heads.

FIGS. 3a and 3b depict example semiconductor light sources in packaged configuration with a heat sink and dome that may be used in backlights, such as in combination with another heat sink.

FIGS. 4a and 4b depict light beam profiles for backlights without and with a reflector or lens.

FIG. 5 depicts a cross sectional view of a backlight casing and contents.

### IV. DETAILED DESCRIPTION

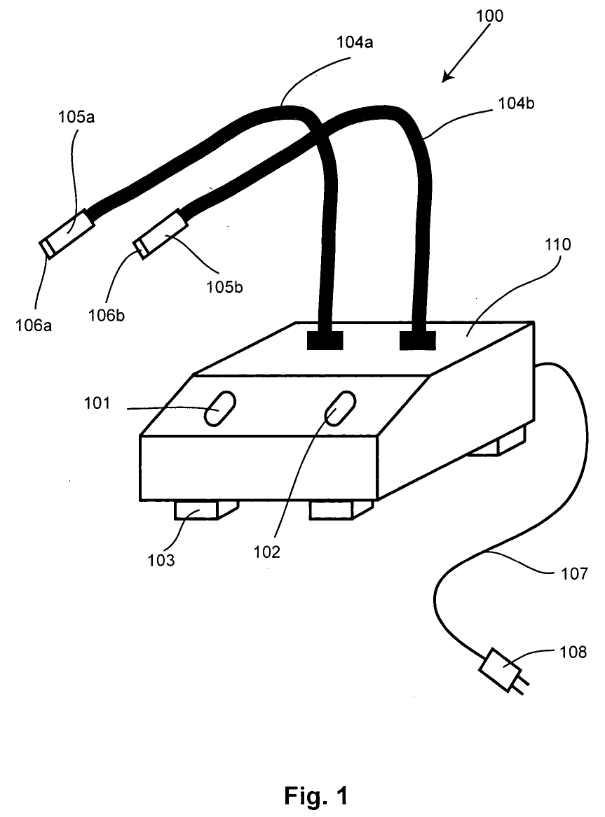

Referring to FIG. 1, an example backlight light 100 is depicted. The backlight 100 includes casing 110 that serves both as a stand and as a container for some electronic componentry. A plug 108 and cord 107 are is provided to receive electrical input, such as from an AC wall outlet. Footings 103 are provided on which the casing 110 may rest in order to permit ventilation thereunder. Switches 101 and 102 are provided for controlling operation of each of the independent backlight light sources located in heads 105a and 105b. Backlight heads 105a and 105b are connected to the casing 110 via flexible arms 104a and 104b, such as flexible tubing or rubber with bendable wire, so that the arms may be bent and directed to point the heads 105a and 105b or either of them in a desired direction. The heads 105a and 105b each have a cover 106a and 106b which serve to protect the semiconductor light sources within the heads from mechanical and environmental exposure and damage, and which may serve a beam focusing function as well.

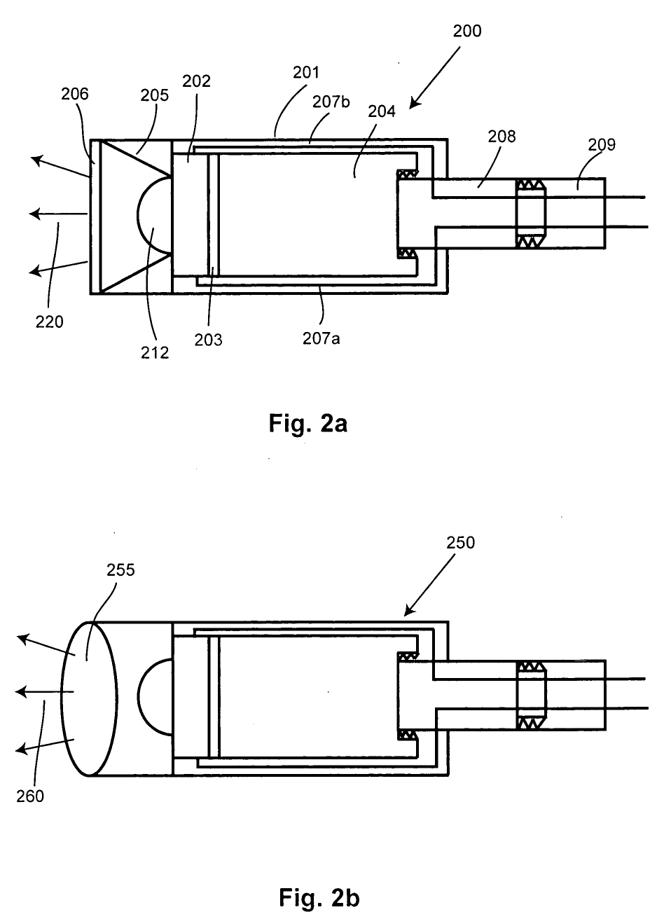

FIGS. 2a and 2b depict cross sectional views of example heads 105a and 105b of a backlight. Referring to FIG. 2a, the example head 200 is affixed to flexible tubing of conduit 209 through which electrical wire 208 passes to provide electrical power to the semiconductor light source with the head. The head 200 has a casing 201 through which electrical wires 207a and 207b pass to provide electrical connection to the light source. A secondary heat sink 204 is provided in the head 200 to draw heat away from the semiconductor light source and dissipate such heat. A semiconductor light source 202 is affixed to the secondary heat sink 204 via an appropriate method such as brazing of by use of heat conductive adhesive 203. The semiconductor light source 202 may include a primary heat sink to which a light emitting semiconductor heat sink is affixed, and optionally a cover or dome 212 over the chip, as described in greater detail herein. Alternatively, a light emitting semiconductor chip may be affixed directly or indirectly to the secondary heat sink 204. In the example depicted, a reflector 205 is provided to gather light emitted by the semiconductor chip in the head and direct it into a useful light beam 220.

Referring to FIG. 2b, another example head 250 is depicted. Example backlight head 250 includes the same components as found in FIG. 2a, except that the reflector has been replaced by a focusing lens 255 to gather and focus light emitted by the chip in the head into a light beam 260 proceeding in a useful direction. Use of a reflector of focus beam provides light intensity where it is needed most in a light beam profile for a backlight.

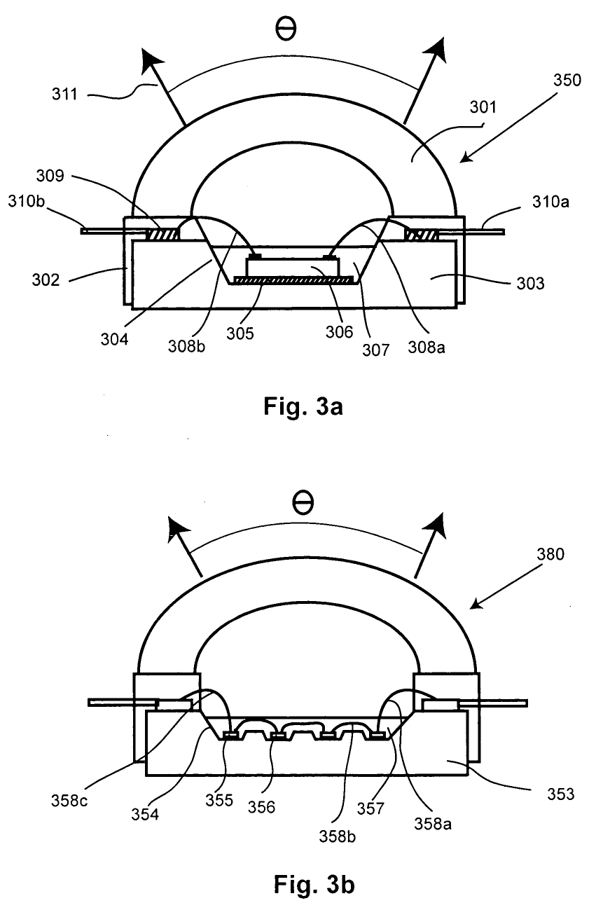

Referring to FIG. 3a, a high power LED package 350 is depicted using a single chip or chip array 306. The chip 306 is mounted in the well 304 of a primary heat sink 303 using heat conductive and light reflective adhesive 305. The primary heat sink may be electrically conductive or electrically insulative as desired. The primary heat sink may be surrounded by a known insulating material 302 that can serve the purpose of electrical and/or heat insulation. The walls and bottom of the well may be polished to be light reflective, or may be covered, plated, painted or bonded with a light-reflective coating such as Al, Au, Ag, Zn, Cu, Pt, chrome, other metals, plating, plastic and others to reflect light and thereby improve light source efficiency. Electrodes 310a and 310b and/or connection blocks 309 may be provided for electrical connection of the chip 306. Wires 308a and 308b may establish electrical connection between the electrodes and the chip. If desired, a coating 307 may be presented over the chip, such as a white phosphor coating to convert light emitted by the chip to white light. The coating may be only on the chip, or may fill or partially fill the well. An optical dome or cover 301 may optionally be provided for the purpose of protecting the chip and its assemblies, and for the purpose of focusing light emitted by the chip. The dome may be made of any of suitable material such as plastic, polycarbonate, epoxy, glass and others. The configuration of the well and the dome provide for light emission along an arc of a circle defined by ⊖ in a desired direction 311. The dome 301 may serve the function of protecting the chip(s) from dirt, moisture, contaminants and mechanical damage. It may also serve the function of focusing light emitted by the chip(s) or otherwise modifying the light beam to a desired configuration or footprint.

FIG. 3b depicts a similar arrangement for a chip package 380 in which the heat sink 353 has multiple sub wells 355 each of which has a chip 356 located within it. Wires 358a, 358b and 358c provide the chips with power. The sub wells 355 are located within primary well 354. Optionally, a coating 357 may be provided to convert light emitted by the chips to a desired wavelength configuration, such as white light. In this example, the coating covers the chips and fills the sub-wells but only partially fills the primary well.

Considering FIGS. 3a and 3b in conjunction with FIGS. 2a and 2b, the primary heat sink may be attached to the secondary heat sink in order to create a heat conductance path from the chip to the primary heat sink and thence to the secondary heat sink. The secondary heat sink can serve as a mounting location for multiple semiconductor light sources or semiconductor light source modules as desired to achieve sufficient light intensity. The secondary heat sink 101 also serves to draw heat away from semiconductor light sources or semiconductor light sources modules and any primary heat sinks that they may include. Semiconductor light sources used in the backlights may be packaged or non-packaged semiconductors that emit light when provided with electrical power. Example semiconductor light sources include light emitting diodes (LED's), LED arrays, vertical cavity surface emitting laser (VCSEL's), VCSEL arrays, photon recycling devices that cause a monochromatic chip to emit white light, and others, in any desired configuration. Direct mount, surface mount, flip chip and any other desired chip mounting configuration may be employed. The chips may be chosen to emit a desired wavelength for use when examining a particular material under magnification. As different wavelengths of light may help to illuminate or detect different substances, appropriate semiconductor chips may be chosen when constructing the backlight.

The heat sinks in the backlight may be any material capable of conducting heat away from the semiconductor light sources. The heat sink(s) may be of a single material or a combination of two different kinds of materials, the first with a low thermal expansion rate and the second with high thermal conductivity. Monolithic heat sinks may be used as well. Examples of some heat sink materials which may be used in lights depicted herein include ceramic, powdered metal, copper, aluminum, silver, magnesium, steel, silicon carbide, boron nitride, tungsten, molybdenum, cobalt, chrome, Si, SiO₂, SiC, AlSi, AlSiC, natural diamond, monocrystalline diamond, polycrystalline diamond, polycrystalline diamond compacts, diamond deposited through chemical vapor deposition and diamond deposited through physical vapor deposition, and composite materials or compounds. Any materials with adequate heat conductance and/or dissipation properties can be used.

Mounting of any semiconductor chip or light module may be achieved by a variety of methods, including mechanical fixation (clips, press-fit, screws, rivets, etc.), brazing, welding, use of an adhesive or other methods. Use of a heat conductive and/or electrically insulative adhesive may be desired. Examples of heat conductive and/or electrically insulative adhesives which may be used are silver based epoxy, other epoxies, and other adhesives with a heat conductive quality and/or electrically insulative quality. In order to perform a heat conductive function, it is important that the adhesive possess the following characteristics: (i) strong bonding between the materials being bonded, (ii) adequate heat conductance, (iii) electrically insulative or electrically conductive if desired (or both), and (iv) light reflectivity if desired, or any combination of the above. Examples of light reflective adhesives which may be used include silver and aluminum based epoxy. One example heat conductive and electrically insulative adhesive includes a mixture of a primer and an activator. In this example, the primer may contain one or more heat conductive agents such as aluminum oxide (about 20-60%) and/or aluminum hydroxide (about 15-50%). The primer may also contain one or more bonding agents such as polyurethane methacrylate (about 8-15%), and/or hydroxyalkyl methacrylate (about 8-15%). An activator may be mixed with the primer to form an adhesive. The activator may include any desired catalyst, for example n-heptane (about 5-50%), aldheyde-aniline condensate (about 30-35%), isopropyl alcohol (about 15-20%), and an organocopper compound (about 0.01 to 0.1%). Adhesives such as described herein can be used to mount a chip to a primary heat sink, or to mount a primary heat sink to a secondary heat sink, or both.

The semiconductor light sources can include semiconductor chips that emit light when provided with electrical power. The chips may include any of a variety of materials known for constructing chips that emit light. The chips may include a variety of epitaxial layers grown on a substrate. Examples of substrates on which the semiconductors used in the lights depicted herein may be grown include Si, GaAs, GaN, ZnS, ZnSe, InP, Al₂O₃, SiC, GaSb, InAs and others. Both electrically insulative and electrically conductive substrates may be used.

If desired, any of the heat sinks of the backlight may include a thermoelectric cooler on them to enhance cooling. A thermoelectric cooler tends to provide a cooling effect when electrically charged, thereby assisting in keeping the light cool, preventing overheating of semiconductors which may decrease their efficiency or life, and prevents the backlight from becoming hot enough to danger its surrounding environment. Example materials which may be used in a thermoelectric cooler in backlights include Bi₂Te₃, PbTe, SiGe, BeO₂, BiTeSe, BiTeSb, AlO₃, AlN, BaN and others.

The primary heat sink is typically either of lesser mass or lesser interior volume or both than the primary heat sink. A cover may be provided that covers the semiconductor light sources if desired.

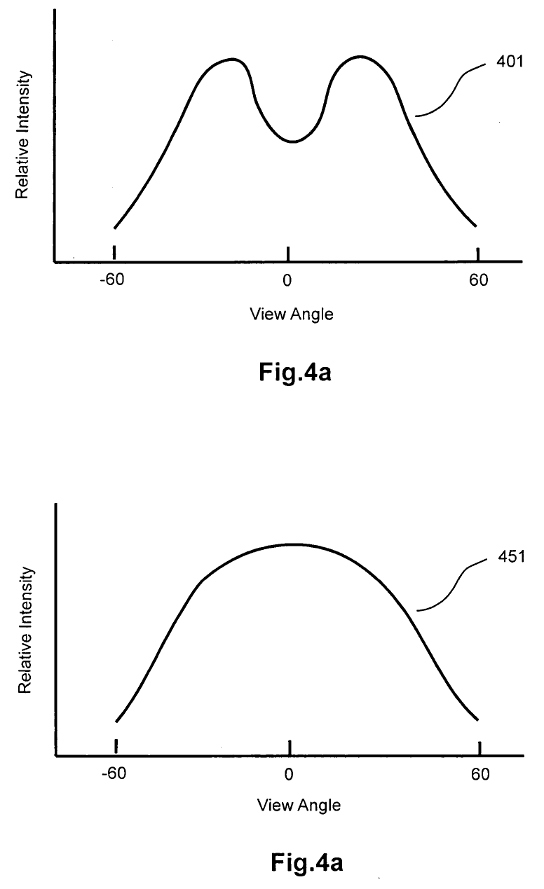

Referring to FIG. 4a, a beam profile 401 of a light beam from a backlight is depicted, showing relative intensity compared to view angle. From the figure, it can be seen that the beam profile has two peaks that are not centered around 0 degrees view angle. When a reflector or lens is used as discussed above, a beam profile 451 can be created that peaks around a 0 degree view angle for maximum intensity viewing, as depicted in FIG. 4b.

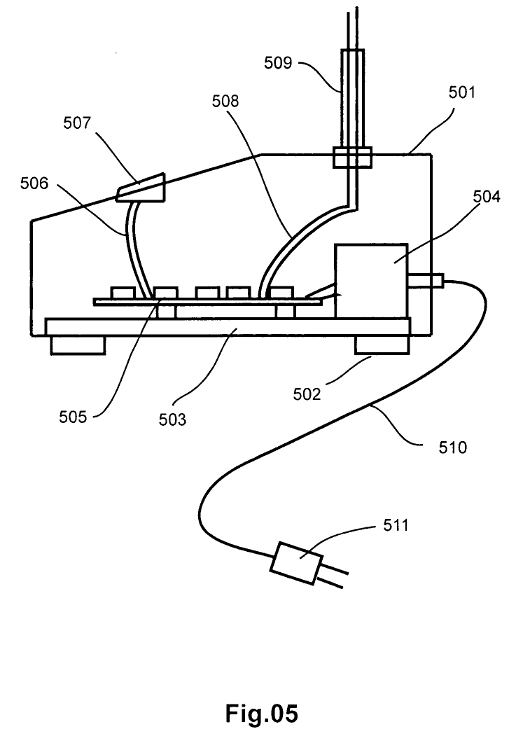

Referring to FIG. 5, a cross sectional side view of a back light is depicted. A casing or housing 501 contains a switch and power supply 504. Footers 502 are provided under the casing to elevate it from the floor and to provide ventilation under the backlight. A weight plate 502 may be placed in the casing to weight the unit down. A constant current source 505 is provided to power the semiconductor light sources. Switches 507 permit a user to use hands or feet to control operation of the backlight. Wires 506 transmit the user's signals from articulating the switches to the backlight control circuitry. Wires 508 provide electrical power through conduit or tubing 509 to the semiconductor light sources in the heads (now shown). A cord 510 and plug 511 provide for receiving electrical power from a wall outlet.

While devices have been described and illustrated in conjunction with a number of examples, those skilled in the art will appreciate that variations and modifications may be made without departing from the principles of the invention as defined in the appended claims. The invention may be embodied in other specific forms without departing from its spirit or essential characteristics. The described embodiments are considered in all respects to be illustrative and not restrictive. The scope of the invention is, therefore, indicated by the appended claims, rather than by the foregoing description. All changes which come within the meaning and range of equivalence of the claims are to be embraced within their scope.

1. An backlight for providing lighting to an object that is to undergo magnification by a microscope, the backlight comprising:
a housing,
control circuitry located within said housing for controlling operation of the backlight,
at least one switch in electrical communication with said control circuitry for a user to initiate and terminate light transmission from the backlight,
at least one flexible conduit having a proximal end and a distal end, said flexible conduit proximal end extending from said housing,
said flexible conduit being bendable and positionable in order to direct light in a particular direction,
said flexible conduit having wire for the purpose of providing electrical power to a semiconductor light source located at said flexible conduit distal end,
a head located at said flexible conduit distal end,
a semiconductor light source module at said head,
said semiconductor light source module including
a primary heat sink,
a light emitting semiconductor chip affixed to said primary heat sink, and
a secondary heat sink, said primary heat sink being affixed to said secondary heat sink, and
a heat conductance path beginning with said semiconductor chip which emits both light and heat when it is powered, said heat flowing to said primary heat sink and thence to said secondary heat sink.

2. A device as recited in claim 1 further comprising:
a reflector at said head for gathering and reflecting light emitted by said semiconductor chip into a useful light beam.

3. A device as recited in claim 1 further comprising:
a lens at said head for gathering and focusing light emitted by said semiconductor chip into a useful light beam.

4. A device as recited in claim 1 further comprising a dome over said semiconductor chip.

5. A device as recited in claim 1 further comprising a coating on said semiconductor chip for converting light emitted by said chip to white light.

6. A device as recited in claim 3 wherein the backlight provides a light beam with a light profile that peaks in relative intensity at about a 0 degree view angle.

7. A device as recited in claim 4 wherein the backlight provides a light beam with a light profile that peaks in relative intensity at about a 0 degree view angle.

8. An backlight for providing lighting to an object that is to undergo magnification by a microscope, the backlight comprising:
a housing,
at least one flexible conduit having a proximal end and a distal end, said flexible conduit proximal end extending from said housing,
said flexible conduit being positionable in order to direct light in a particular direction,
a semiconductor light source module at said flexible conduit distal end, and
a light beam modifying device that modifies light from said semiconductor light source to provide a light beam with a light profile that peaks in relative intensity at about a 0 degree view angle.

9. A device as recited in claim 8 wherein said semiconductor light source module includes
a primary heat sink,
a light emitting semiconductor chip affixed to said primary heat sink, and
a secondary heat sink, said primary heat sink being affixed to said secondary heat sink, and
a heat conductance path beginning with said semiconductor chip which emits both light and heat when it is powered, said heat flowing to said primary heat sink and thence to said secondary heat sink.

10. A device as recited in claim 9 wherein said semiconductor light source includes:
a well,
said chip being mounted in said well,
and said coating at least partially filling said well.

11. A device as recited in claim 9 wherein said semiconductor light source includes:
a primary well,
a plurality of sub-wells located in said primary wells,
a plurality of light emitting semiconductor chips located in said sub-wells.

12. A device as recited in claim 11 wherein said coating fills said sub-wells and wherein said coating at least partially fills said primary well.

13. A device as recited in claim 9 further comprising a quantity of heat-conductive adhesive that secures said primary heat sink to said secondary heat sink.

14. A device as recited in claim 10 further comprising a quantity of light-reflective adhesive that secures said chip to said primary heat sink.

15. A device as recited in claim 10 further comprising a dome over said primary heat sink, said dome serving to focus light emitted by said chip and direct it in an arc of a circle defined by ⊖.

16. A device as recited in claim 9 wherein said primary heat sink has a smaller interior volume than said secondary heat sink.

17. A device as recited in claim 8 further comprising:
a reflector at said head for gathering and reflecting light emitted by said semiconductor chip into a useful light beam.

18. A device as recited in claim 8 further comprising:
a lens at said head for gathering and focusing light emitted by said semiconductor chip into a useful light beam.

19. A device as recited in claim 9 further comprising a dome over said semiconductor chip.

20. An backlight for providing lighting to an object that is to undergo magnification by a microscope, the backlight comprising:
a housing,
at least one flexible conduit having a proximal end and a distal end, said flexible conduit proximal end extending from said housing,
said flexible conduit being positionable in order to direct light in a particular direction,
a semiconductor light source module at said flexible conduit distal end, and
a light beam modifying device that modifies light from said semiconductor light source to provide a light beam with a light profile that peaks in relative intensity at about a 0 degree view angle, said light beam modifying device being selected from the group consisting of reflectors and lenses.
